(19) United States
(12) Patent Application Publication
(10) Pub. No.: US 2020/0117808 A1
(43) Pub. Date: Apr. 16, 2020

(54) Electronic System Vulnerability Assessment

(71) Applicants: Arm Limited, Cambridge (GB); Arm IP Limited, Cambridge (GB)

(72) Inventors: John Eugene Neystadt, Kfar-Saba (IL); Milosch Meriac, Cambridge (GB); Roni Sasson, Raanana (IL)

(73) Assignees: Arm Limited, Cambridge (GB); Arm IP Limited, Cambridge (GB)

(21) Appl. No.: 16/624,765

(22) PCT Filed: Jun. 18, 2018
(86) PCT No.: PCT/GB2018/051683

§ 371 Date: Dec. 19, 2019

(30) Foreign Application Priority Data
Jun. 20, 2017 (GB) 1709841.9

(51) Int. Cl. G06F 21/57; G06F 21/56

(52) U.S. Cl. CPC G06F 21/577; G06F 2221/033; G06F 21/562

(57) ABSTRACT

A method and apparatus for assessing vulnerability in a system of electronic devices, comprises determining a distinguishing characteristic of a version of a computer program as installed in a usable format to distinguish that version from at least one further version; identifying an indication of a defect giving rise to vulnerability to malicious activity in code or data used by the distinguished version; maintaining a mapping between the distinguished and the indication; scanning the system for presence of the distinguished version; determining that a vulnerable portion is used by the distinguished version; and in response indicating with a vulnerability indicator that the electronic device is vulnerable to the malicious activity according to the mapping; assigning a risk value associated with the installed instance; and emitting an alert signal identifying the vulnerability and indicating the risk value associated with the installed instance. The scanning is further controlled to prevent exposure of sensitive code and data.

### CROSS-REFERENCE TO RELATED APPLICATIONS

This application is the National Stage of International Application No. PCT/GB2018/051683, filed on Jun. 18, 2018, which claims priority to foreign patent application no. GB 1709841.9 filed on Jun. 20, 2017, the contents of which are incorporated herein by reference in their entireties.

### BACKGROUND

The present technology relates to apparatus and methods for operating electronic systems to assess the vulnerability of one or more system devices or logical components (such as software and firmware) to malicious code.

It is generally acknowledged that all electronic devices and logical components have some level of vulnerability to malicious code, such as viruses, worms, Trojan horses and the like. During the lifetime of a software or hardware component, new vulnerabilities are frequently discovered, for example, when they are found and exploited by the malicious, or when they are discovered by those concerned with the security of systems. For the developer of electronic systems, one challenge is to detect the potential of such newly-found vulnerabilities to affect installed systems, to assess their potential effects on the device, component or wider system, and to devise means of preventing or mitigating such effects.

### BRIEF DESCRIPTION OF THE DRAWINGS

Implementations of the disclosed technology will now be described, by way of example only, with reference to the accompanying drawings, in which:

FIG. 1 shows a method of operation according to one implementation of the present technology;

FIG. 2 shows a further method of operation according to an implementation of the present technology;

FIG. 3 shows the components of a system (which may comprise any combination of hardware, software and firmware entities) according to implementations of the present technology;

FIG. 4 shows an example of a vulnerability discovered in a linked-in library entity;

FIG. 5 shows a real-world example of a first variant of the present technology; and

FIG. 6 shows a real-world example of a second variant of the present technology.

### DETAILED DESCRIPTION

In various implementations, a first approach in the present technology provides a machine-implemented method for assessing vulnerability of an electronic device in a system of electronic devices, comprising: determining a distinguishing characteristic of at least one version of a computer program as installed in a usable format to distinguish the at least one version of the computer program in the format from at least one further version of the computer program in the format; identifying at least one indication of a defect giving rise to vulnerability to malicious activity in a portion of at least one of code and data used by the at least one version of the computer program; maintaining a mapping between the at least one version of the computer program and the at least one indication; scanning the system for presence of the distinguishing characteristic of the at least one version of the computer program in the system of electronic devices; determining that the portion of at least one of code and data is used by the at least one version of the computer program; responsive to a determination that an electronic device has at least one installed instance of the at least one version of the computer program, indicating with at least one vulnerability indicator that the electronic device is vulnerable to the malicious activity according to the mapping; assigning to the at least one vulnerability indicator a risk value associated with the installed instance; and emitting an alert signal identifying the vulnerability and indicating the risk value associated with the installed instance.

In various implementations, a second approach in the present technology provides a machine-implemented vulnerability detection method for a local electronic device in a system of electronic devices, comprising: determining a distinguishing characteristic of at least one version of a computer program in a format as installed in usable form on at least one local electronic device to distinguish the at least one version of the computer program in the format from at least one further version of the computer program in the format; at least one of generating at a remote device and receiving at the local device at least one indication of a defect giving rise to vulnerability to malicious activity in a portion of at least one of code and data; determining that the portion is used by the at least one version; maintaining a mapping between the at least one version of the computer program and the at least one indication; creating a first scanning rule comprising the distinguishing characteristic and the indication; determining a level of trust for a scanner; creating a second scanning rule comprising the level of trust; storing the first and the second scanning rules in at least one of the local device and a remote device; scanning according to the stored first scanning rule only portions of storage on the local device that are available according to the level of trust in the second scanning rule to detect instances of the distinguishing characteristic in at least one usable computer program in at least one of an installed state and a to-be-installed state thereon, the act of scanning being performed by at least one of the local device and the remote device; and responsive to a determination that the electronic device has an installed instance of the at least one version of the computer program according to the distinguishing characteristic of the first scanning rule, emitting an alert signal indicating that the electronic device is vulnerable to the malicious activity according to the indication.

In a typical modern system environment, electronic devices of many kinds are typically networked to gather, process, store and analyse data. These devices, which are often geographically widely spread, are typically initially provisioned and later updated with firmware and software over communications media, which may be wired or wireless.

In recent times, the phenomenon of the Internet of Things (IoT) has developed, whereby devices that were previously isolated and lacking local processing capabilities are provided with connectivity and local processing functionality. In the IoT environment, disparate types of devices—sensors, actuators and the like, may be embedded in conventional appliances, such as air-conditioning equipment, refrigerators, heaters and the like, and may be connected over the Internet with many cooperating devices and systems. In such an environment, vulnerabilities in software and firmware may be exploited by the malicious to gain profit or to cause harm.

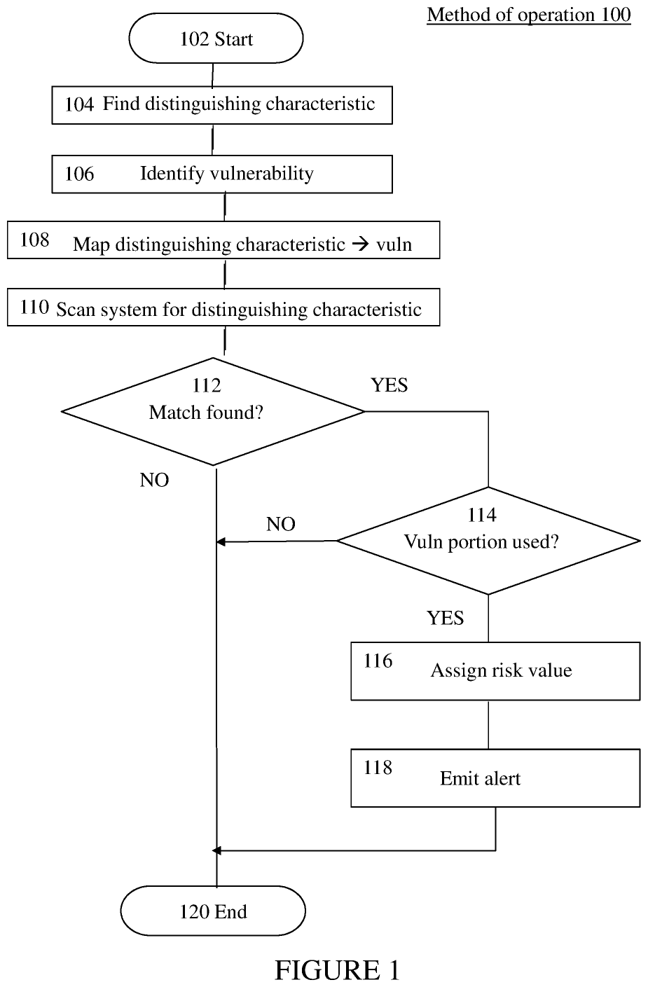

With reference now to FIG. 1, there is shown a method of operation 100 according to an implementation of the present technology. The process commences at START step 102, and at step 104 a distinguishing characteristic of a version of a program or data entity is found. A program entity may comprise, for example, a link library, a remote callable procedure, or the like. A data entity may comprise, for example, a cryptographic key string, corruption of which by malicious activity could be damaging in many ways. The characteristic may be as simple as a literal constant character string naming the version of the program or data entity, or it may be any of the many possible more complex characteristics, such as a watermark in the code. The distinguishing characteristic might be, for example, a regular expression, or it might also contain “do not care” elements. Thus, for example, the characteristic pattern may consist of multiple entities (such as bytes or other bit patterns) in the code or data, which do not need to be contiguous. Additionally, the distinguishing characteristic might consist of discrete patterns, the proximity of which to each other might comprise the distinctive identifying feature.

A vulnerability in at least one version of a program or data entity is identified (for example, by reference to a database of known vulnerabilities, such as the Common Vulnerabilities and Exposures repository CVE) at step 106, and at step 108, the distinguishing characteristic of the version is associated with the identified vulnerability. As would be clear to one of skill in the art, these steps are not necessarily performed in this sequence—they may be ordered differently, and indeed, in some systems, steps may be performed in parallel. At step 110, the system is scanned to locate any system entity that contains the distinguishing characteristic—a positive outcome at test step 112 indicates that at least one of the system entities uses the version of a program or data entity that is associated with the identified vulnerability. The distinguishing characteristic may additionally cover a range of versions, so that several vulnerable entities may be scanned for and detected.

If the distinguishing characteristic is not found at test step 112, this instance of the process completes at END step 120, and the process is freed to return to START step 102 to proceed with a further iteration.

If the distinguishing characteristic is found at test step 112, at optional test step 114 it may be determined whether a vulnerable portion of the program or data entity is used by the installed instance of the version of the program or data entity.

If the outcome of test step 114 is negative, no further action needs to be taken, this instance of the process completes at END step 120, and the process is freed to return to START step 102 to proceed with a further iteration.

If the outcome of test step 114 is positive, indicating that a vulnerable portion of the program or data entity is used by the installed instance of the version of the program or data entity, at step 116, a risk value associated with the identified vulnerability is assigned. The risk value may be, for example, derived from the Common Vulnerability Scoring System (CVSS). At step 118 an alert is emitted, so that appropriate action can be taken, typically by an operator action or by an automated correction or mitigation process. This instance of the process then completes at END step 120, and the process is freed to return to START step 102 to proceed with a further iteration.

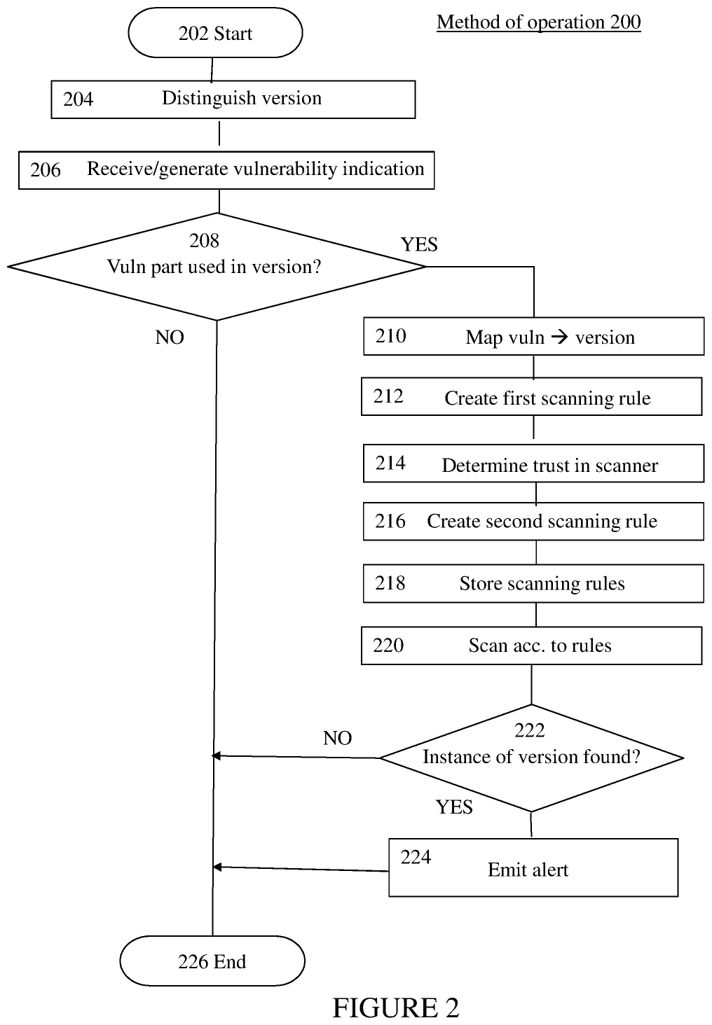

With reference now to FIG. 2, there is shown a further method of operation 200 according to one implementation of the present technology. This aspect of the technology addresses the requirement for the refinement of access control. As will be realised by one of skill in the art, it is necessary to deploy all possible means to protect sensitive data assets, such as personally-identifiable information, cryptographic keys, and the like. Such data assets may be contained in the same storage medium as the program and data entities that require scanning for vulnerabilities, and thus it may be necessary to control the scan to ensure that the sensitive data assets cannot be exposed in the process.

With this need in mind, method of operation 200 starts at START step 202, and at step 204 a version of a program or data entity is distinguished by identification of a distinguishing characteristic. A program entity may comprise, for example, a link library, a remote callable procedure, or the like. A data entity may comprise, for example, a cryptographic key string, corruption of which by malicious activity could be damaging in many ways. The characteristic may be as simple as a literal constant character string naming the version of the program or data entity, or it may be any of the many possible more complex characteristics, such as a watermark in the code. The distinguishing characteristic may additionally cover a range of versions, so that several vulnerable entities may be scanned for and detected. At step 206, a vulnerability indicator is either received or generated. Typically, a vulnerability indicator is generated at a central location, based on reports of a defect in code or data that provides an attack surface for exploitation by the maliciously-inclined. The well-known CVE repository provides such vulnerability indicators. At test step 208, it is determined whether a version of a code or data entity as distinguished at step 204 uses a vulnerable part of the code or data entity.

If the outcome of test step 208 is negative, no further action is required, this instance of the process completes at END step 226, and the process is freed to return to START step 202 to proceed with a further iteration.

If the outcome of test step 208 is positive, at step 210, the vulnerability indicator is mapped to the version of the program or data entity. The mapping is typically stored on a storage medium, which may be of any type, for use by at least one instance of the method of the present technology. At step 212, a first scanning rule is created using the version of the program or data entity and its mapping to a vulnerability indicator. At step 214, the level of trust to be accorded to the scanner is determined, and at step 216, a second scanning rule is created according to the level of trust. This second scanning rule is necessitated by the need described above to protect sensitive data locations. The scanning rule may, for example, be derived from the device configuration, such as the storage structure in the device or its firmware. One example might be the memory protection configuration of the device, or some other rule determining the accessibility of some part of the storage. The first and second scanning rules are stored at 218, so that they can be used in at least one instance of the method of the present technology. At step 220, the system is scanned according to the stored scanning rules, to detect the presence of at least one instance of the version of the program or data entity. Sensitive data locations are screened from the scanning according to the second scanning rule.

If at test step 222, no instance of the version is found in the system, no further action is required, this instance of the process completes at END step 226, and the process is freed to return to START step 202 to proceed with a further iteration. If the outcome of test step 222 is positive (that is, an instance of the version is found) at step 224, an alert is emitted, so that appropriate action can be taken, typically by an operator action or by an automated correction or mitigation process. This instance of the process then completes at END step 226, and the process is freed to return to START step 202 to proceed with a further iteration.

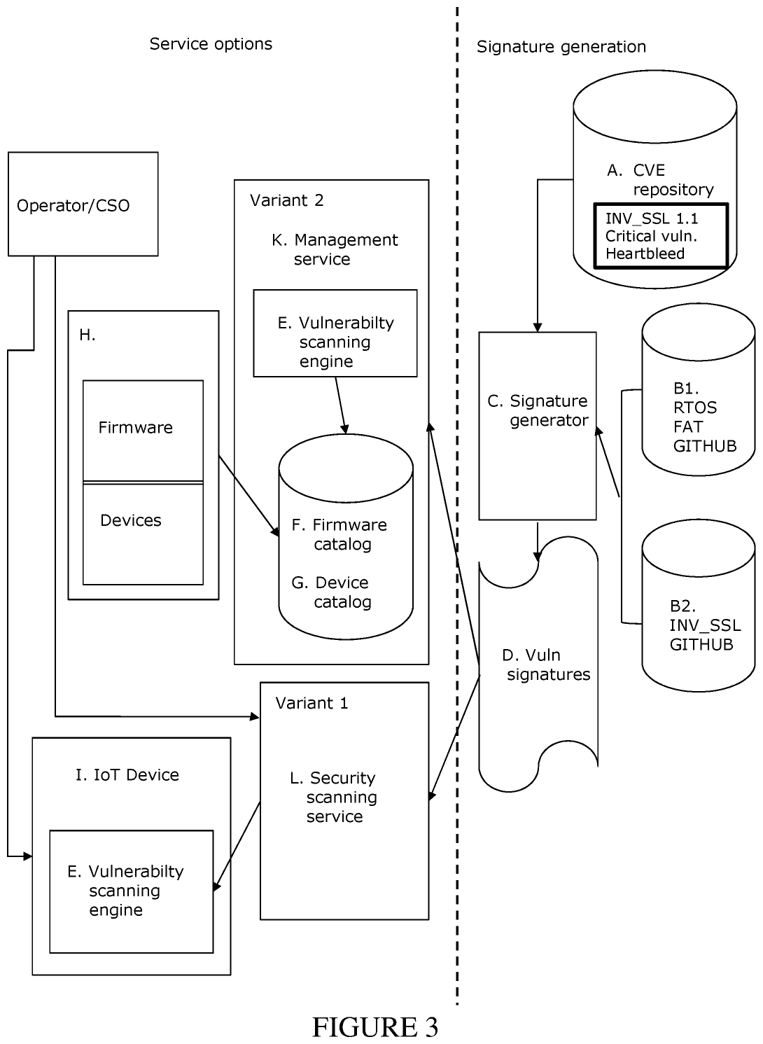

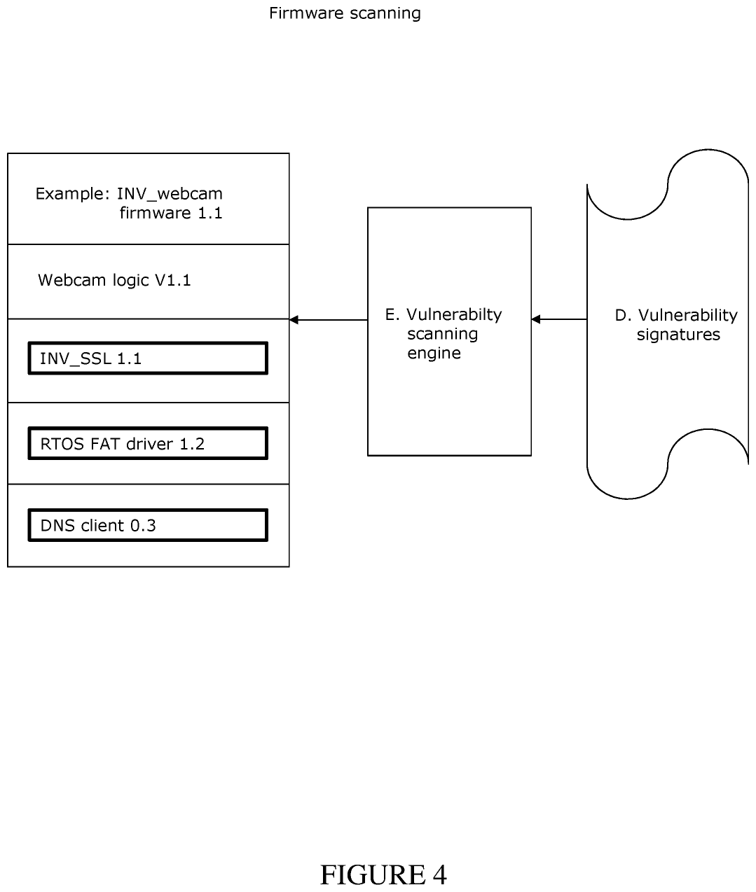

With reference now to FIGS. 3 and 4, a simplified representation of an exemplary IoT system environment according to real-world implementations of the present technology is shown, with alphabetic references for use in the following text (shown in the text in bold type). The exemplary environment comprises code libraries and operating system code elements used by IoT devices, but it will be clear to one of skill in the art that the present technology is not limited to such an environment.

Turning to FIG. 3, when a developer creates a software or firmware entity (H) for an IoT device (I), typically 70-90% of the code used consists of third-party libraries and possibly embedded operating system (OS) code. New security vulnerabilities are frequently discovered in these libraries, and a developer must make sure that the libraries are kept up to date. Moreover, if a vulnerability is discovered after a device is released, firmware must be adapted, tested and rebuilt with the most recent version of the third-party library that fixes the vulnerability. After new firmware is released, the owner or operator of IoT devices must deploy the new firmware update, which usually requires field testing to ensure that the updated firmware does not “break” the deployment.

After a device is released, new vulnerabilities (as shown stored in repository (A) of FIG. 3) in third-party libraries are typically discovered for a considerable time, possibly for years, and the operators of the system must perform vulnerability assessments on whether any of the deployed devices are affected by the newly discovered vulnerabilities.

Because real-world systems typically have many devices, which may have been deployed at different times, different devices in the same system may have different software and firmware versions installed. Often, as the original developer of the firmware has moved on, both a device manufacturer and the operators have lost track of some aspects of the deployment, and may not even know whether any particular device is vulnerable or not.

Moreover, even if a vulnerability is known to be present, because of resource shortages, IT organizations tend to defer patch installation on the grounds that they believe that a particular problem is not “urgent”. For these reasons, a CSO may to audit systems to assess the risk level of the deployed network of devices. In an IoT environment, the difficulty may be exacerbated by the sheer number and variety of devices deployed.

In the IoT example, but not limited to such an environment, as soon as a new vulnerability is publicly disclosed, attackers typically start probing connected IoT devices and trying to compromise them. In a typical current system environment, however, developers, manufacturers, operators and CSOs may often struggle to understand whether their IoT devices are vulnerable or not. In the example shown in FIGS. 3 and 4, INV_SSL 1.1 is recorded in the Common Vulnerability and Exposures (CVE) repository (A) as critically vulnerable to the Heartbleed exploit. In FIG. 4, INV_SSL 1.1 is detected by the present technology as being installed and used by INV_webcam firmware 1.1 via linking from Webcam logic V1.1.

Often, after years of operation of connected devices, an organization may not maintain an up to date catalog of all used firmware images and not have a catalog of all devices with mapping of which firmware version runs on each device.

Additionally, the organization may consider firmware as secret and will not be ready to share it with an external Vulnerability Scanning Service (K). To prepare for this case it is possible to include in advance a vulnerability scanning engine (E) in the devices (I) themselves and expose an option to remotely trigger vulnerability scanning. In this mode, a pre-authorized Vulnerability Scanning IoT Service (L) would request signature generator (C) to produce new vulnerability signatures, send them to the designated device (I), send it the list of vulnerability signatures (D), and let the device itself to perform the scan with scanning engine (E) of its firmware itself and report results to Scanning Service (L). In one implementation, the device would only scan device storage where firmware code sections are stored, but would avoid scanning data section to avoid exposure of sensitive data or key to the service. Local scanning on the device itself is shown as Variant 1 in FIG. 3.

Variant 2, also shown in FIG. 3, permits scanning by a device management service. If a Device Management Service (K) has a catalog of existing devices (G) and their firmware (F), when new vulnerabilities are discovered, a central service, such as a Cloud service can generate (C) updated vulnerability signatures (D) and execute scanning engine (E) on firmware in a firmware repository for vulnerabilities, so that it can report which existing devices are affected and require corrective action, such as patching.

Furthermore, it is possible to integrate this technology with a firmware update capability, so that when a developer publishes a new firmware version for distribution, the technology can automatically scan for new vulnerabilities and emit an alert, possibly reporting the results to the developer uploading the new firmware or to an OEM receiving it, prior to distributing it to devices.

The Management Service can flag in Device Catalog (G) the affected devices as vulnerable, and use this flag, for example, to restrict use of the device. For example, it is possible to avoid sending sensitive data, or to avoid executing actions on, a vulnerable device until it is updated with new firmware, and the vulnerable status is removed.

A vulnerability indicator may be generated to enable detection of a situation in which a vulnerable library has been linked into a firmware binary. Naturally, even when a vulnerable library is used, sometimes the linking firmware may not be affected when a specific vulnerable function or vulnerable configuration is not used. It is thus not possible to automatically verify exploitability of the vulnerability in the firmware, but it is nonetheless best practice to flag any use of the vulnerable library, so that any potential for exploitation is exposed and may be remedied or mitigated.

In one possible implementation applicable to both the above-described variants, a library signature generation tool (C), may operate as follows:
Establish a list of popular third-party libraries in use by embedded firmware developers—this list would need to be populated and updated regularly, either manually or by some intelligent technology.
On a scheduled basis (e.g. weekly or monthly) obtain a list of new vulnerability signatures from Common Vulnerabilities and Exposures (CVE) databases—such a database is represented by (A).
Obtain compiled versions of the third-party libraries from corresponding vendor or pull from an open source code repository and build them using any of the well-known toolchains and processor architectures (B1, B2).
Perform a binary comparison between each version of each of the libraries and identify one or more byte sequences that differentiate a target library from all others, and the target library version from all other versions. The differentiation may comprise finding patterns in position-independent parts of the code or data image, so that the search may be linkage-independent. This can be achieved, for example, by making a copy of the image with the linkage process reversed by reference to the relocation table, thus overcoming the effects of any relocations on the pattern-matching process.
Output a list of produced vulnerability indicators or signatures (D).

For example, it is possible to take the most-frequently-used projects on a repository, such as GITHUB, and automatically compile the latest versions to determine the libraries that are used in the linked images. An intelligent system could then map the included files to the relevant source code, and then seek similar files in the systems under investigation. A correlation between the most-frequently-used projects, the uses of such projects by the system under investigation, and the CVE database could be made

When the signature generation tool has produced its output, the Scanning engine (E) needs to perform the following logic:
Receive a set of pre-generated vulnerability signatures (D) and a firmware image (H).
Perform a firmware binary scan, outputting a list of matching libraries and their versions.
Look up in the CVE database (A) a list of vulnerabilities known for each library version, its CVE-id, description and severity.

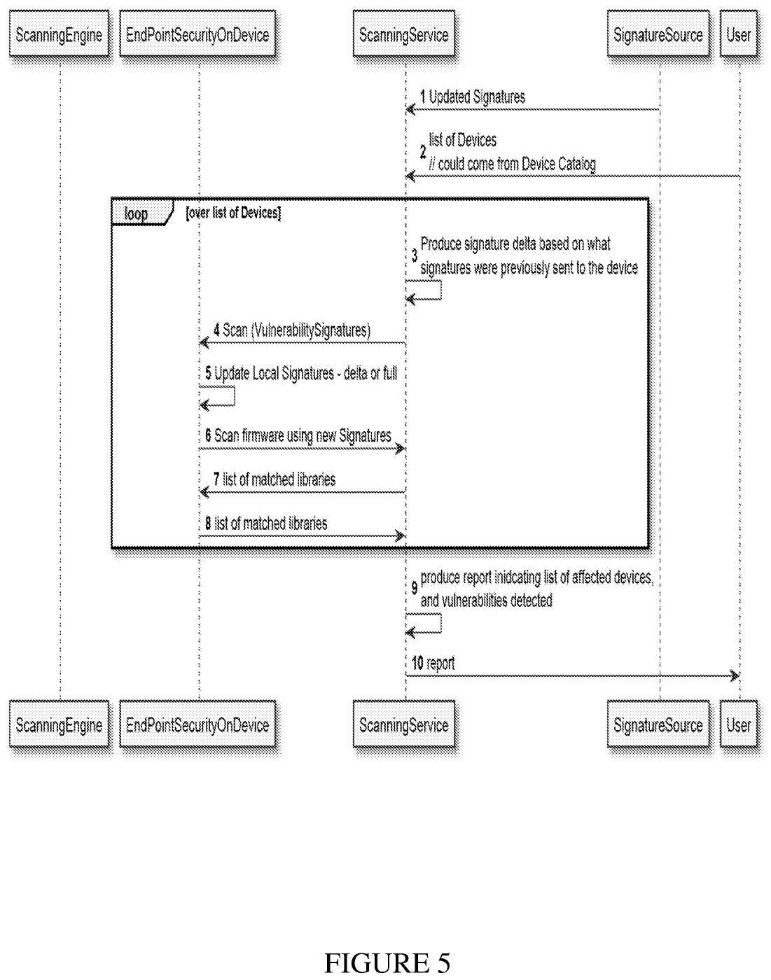

The first variant (Variant 1) mentioned above, in which a local scanning service performs the scan on the local device, will now be described, with reference to FIG. 5:

1. The Scanning Service receives (1) fresh Vulnerability Signatures from a Signature Generation Source, the signatures having been previously generated by the Vulnerability Signature Generator described above.

2. The Scanning Service receives (2) a list of devices to scan. The list can be supplied directly by a user or extracted from a device catalog or inventory if such is available.

3. The Scanning service then loops over list of devices, performing the following for each device:

a. If it is known which version of the signatures the device already has, it can optionally produce (3) a subset of signatures from a previous execution of the process to reduce the size of signature transfer to the device over the network).

b. Send (4) a full list of signatures or the subset delta to the EndPointSecurity module on the device to scan.

4. The EndPointSecurity module merges (5) the delta with existing signature information on the device or replaces existing signatures with the new versions received.

5. The EndPointSecurity module on the device invokes (6) a local vulnerability scanning engine to scan the firmware.

6. The output of the vulnerability scanning engine at (7) is a list of matched vulnerable libraries or vulnerabilities.

7. The EndPointSecurity module emits (8) the output list of matched libraries to the Scanning Service.

8. After receiving scan output from all devices, the Scanning Service constructs (9) a set of data (possibly in the form of a report), with information such as a list and number of affected devices, and how many devices are affected by each of the vulnerability or each severity—For example, 10% of devices have a critical vulnerability and 20% have moderate vulnerability. The vulnerability ranking can be done using some ranking system, such as CVSS, as indicated in the original vulnerability database that was used to produce the signatures.

9. The system then emits (10) alerts (possibly in the form of a report) as appropriate, either to an operator or to an automated system, for correction or mitigation of any vulnerabilities.

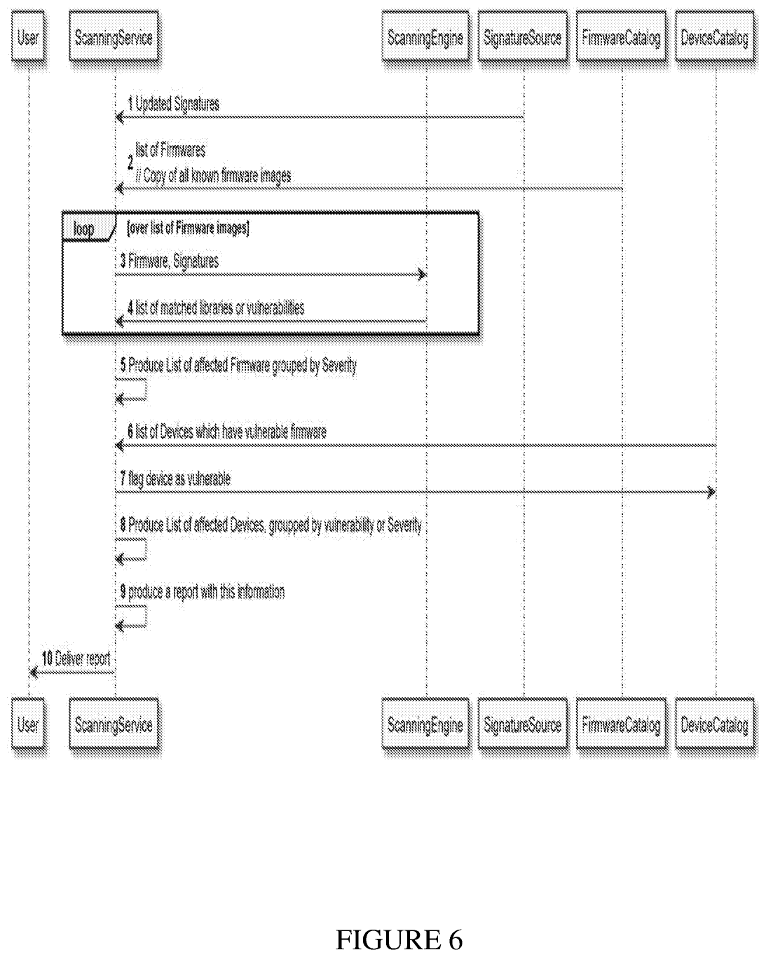

Turning now to FIG. 6, in an implementation of the second of the variants (Variant 2), scanning is performed by a Management Service component, rather than on the local device. In this variant, a Scanning Service:

1. Receives (1) fresh Vulnerability Signatures from the Signature Generation Source, previously generated by the Vulnerability Signature Generator (as described above).

2. Receives (2) a list of firmware versions and files to scan from the Firmware Catalog.

3. Loops over the list of firmware images, for each image performing the following:

a. Invoke (3) a Vulnerability Scanning Engine using the Signature and the Firmware image.

b. Receive (4) from the Vulnerability Scanning Engine a list of vulnerabilities or vulnerable libraries as detected.

4. Groups (5) matched firmware images by vulnerability-id or vulnerability severity as indicated by the severity rating of the matched vulnerability. A ranking system for severities needs to be used—for example, the one described by CVSS.

5. Extracts (6) a list of devices which currently have a vulnerable version of the firmware, and optionally updates the Device Catalog, flagging the devices (7) as vulnerable.

6. Groups (8) the list of affected devices by vulnerability or severity.

7. Produces (9) a report with a raw list of vulnerable devices as found, or with vulnerable devices grouped by vulnerability-id or by vulnerability severity

8. Deliver (10) the acquired data, possibly in the form of a report.

The system then emits alerts as appropriate, either to an operator or to an automated system, for correction or mitigation of any vulnerabilities. Vulnerable devices may be neutralized, for example, by having their access completely revoked. In one alternative, they may be restricted in use, for example by not allowing them to trigger sensitive actions or receive sensitive information.

Both variants (Variant 1 and Variant 2) may be further refined to incorporate the protective measures described above to ensure that sensitive data is not exposed during the scanning process. In both variants, determining a distinguishing characteristic may comprise finding at least one of a clear text instance of a version indicator, an encoding of a version indicator, or a sequence of symbols unique to at least one of said version and a range of versions. The indication of a defect may include an indication of an exploitable program data construct, for example, a stack. The code or data may include at least one an object in an object-oriented system, a local code procedure or a remote called procedure in a procedural code environment, a data definition for defining a portion of a memory, or a cryptographic key structure. Maintaining a mapping can include maintaining a mapping in local or remote volatile or non-volatile storage.

In a method having scanning control according to a level of trust, the level of trust may include, for example, an access control level in an access control hierarchy, a memory privilege key, or an administrator permission level above a user permission level. The format as installed in usable form could be the format of a compiled object, a compiled and linked object, or a compiled, linked and loaded object. The local electronic device could be, for example, an Internet of Things device, and the remote device may be, for example, an Internet of Things deployment device or an Internet of Things management server device.

The method of the present technology may further, responsive to emitting an alert signal, cause performance of an automated mitigation action, such as isolating the vulnerable electronic device from communication with the remainder of the system of electronic devices.

As will be appreciated by one skilled in the art, the present technique may be embodied as a system, method or computer program product. Accordingly, the present technique may take the form of an entirely hardware embodiment, an entirely software embodiment, or an embodiment combining software and hardware. The components described may thus comprise discrete hardware devices, core elements of devices, software or firmware entities, or hybrid hardware/software/firmware entities.

Furthermore, the present technique may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

In a further alternative, present techniques provide a library signature generation device having logic components adapted to generate a list of vulnerability indicators or signatures for assessing a vulnerability of an electronic device in a system of electronic devices, the library signature generation device comprising: receiving logic to receive a distinguishing characteristic of at least one version of a computer program as installed in a usable format to distinguish said at least one version of the computer program in the format from at least one further version of the computer program in the format; identification logic to identity at least one indication of a defect giving rise to vulnerability to malicious activity in a portion of at least one of code and data used by said at least one version of the computer program; mapping logic to map between said at least one version of the computer program and the at least one indication; and output logic to output a list of generated vulnerability indicators or signatures.

The library signature device may carry a machine-implemented method of generating vulnerability indicators or signatures for assessing a vulnerability of an electronic device in a system of electronic devices, the method comprising: receiving a distinguishing characteristic of at least one version of a computer program as installed in a usable format to distinguish said at least one version of the computer program in the format from at least one further version of the computer program in the format; identifying at least one indication of a defect giving rise to vulnerability to malicious activity in a portion of at least one of code and data used by said at least one version of the computer program; mapping between said at least one version of the computer program and the at least one indication; and outputting a list of generated vulnerability indicators or signatures.

In a further alternative a scanning device having logic components is adapted to receive a list of vulnerability indicators or signatures for assessing a vulnerability of an electronic device in a system of electronic devices, the scanning device comprising scanning logic to scan the system for presence of a distinguishing characteristic of at least one version of a computer program as installed in a usable format to distinguish said at least one version of the computer program in the format from at least one further version of the computer program in the format; determining logic to determine that the portion of at least one of code and data is used by the at least one version of the computer program; and responsive logic to determine that an electronic device has at least one installed instance of said at least one version of said computer program, indicator logic to indicate with at least one vulnerability indicator that the electronic device is vulnerable to said malicious activity; and output logic to output an alert to either an operator or to an automated system.

The scanning device may carry out a machine-implemented method of generating a set of data assessing a vulnerability of an electronic device in a system of electronic devices, the method comprising scanning the system for presence of a distinguishing characteristic of at least one version of a computer program as installed in a usable format to distinguish said at least one version of the computer program in the format from at least one further version of the computer program in the format; determining that the portion of at least one of code and data is used by the at least one version of the computer program; and determining that an electronic device has at least one installed instance of said at least one version of said computer program, indicating with at least one vulnerability indicator that the electronic device is vulnerable to said malicious activity; and outputting an alert to either an operator or to an automated system.

It will be clear to one skilled in the art that many improvements and modifications can be made to the foregoing exemplary embodiments without departing from the scope of the present technique.

1. (canceled)

2. A machine-implemented vulnerability detection method for a local electronic device in a system of electronic devices, comprising:
determining a distinguishing characteristic of at least one version of a computer program in a format as installed in usable form on at least one local electronic device to distinguish said at least one version of said computer program in said format from at least one further version of said computer program in said format;
at least one of generating at a remote device and receiving at said local device at least one indication of a defect giving rise to vulnerability to malicious activity in a portion of at least one of code and data;
determining that said portion is used by said at least one version;
maintaining a mapping between said at least one version of said computer program and said at least one indication;
creating a first scanning rule comprising said distinguishing characteristic and said indication;
creating a second scanning rule according to a level of trust for a scanner;
storing said first and said second scanning rule comprising according to a s in at least one of said local device and a remote device;
scanning according to said stored first scanning rule only portions of storage on said local device that are available according to said second scanning rule to detect instances of said distinguishing characteristic in at least one usable computer program in at least one of an installed state and a to-be-installed state thereon, the act of scanning being performed by at least one of said local device and said remote device; and
responsive to a determination that said electronic device has an installed instance of said at least one version of said computer program according to said distinguishing characteristic of said first scanning rule, emitting an alert signal indicating that said electronic device is vulnerable to said malicious activity according to said indication.

3. The method of claim 2, said determining a distinguishing characteristic comprising finding at least one of a clear text instance of a version indicator, an encoding of a version indicator, and a sequence of symbols unique to at least one of said version and a range of versions.

4. The method of claim 2, said indication of a defect comprising an indication of an exploitable program data construct.

5. The method of claim 4, said exploitable program data construct comprising a stack.

6. The method of claim 2, said at least one of code and data comprising at least one of an object, a local code procedure, a remote called procedure, a data definition for defining a portion of a memory, and a cryptographic key structure.

7. The method of claim 2, said maintaining a mapping comprising maintaining a mapping in at least one of local volatile storage, local non-volatile storage, remote volatile storage and remote non-volatile storage.

8. The method of claim 2, said level of trust comprising one of an access control level in an access control hierarchy, a memory privilege key, and an administrator permission level above a user permission level.

9. The method of claim 2, said format as installed in usable form comprising at least one of a compiled object format, a compiled and linked object format and a compiled, linked and loaded object format.

10. The method of claim 2, said local electronic device comprising an Internet of Things device.

11. The method of claim 2, said remote electronic device comprising at least one of an Internet of Things deployment device and an Internet of Things management server device.

12. The method of claim 2, further comprising, responsive to said alert signal, performing an automated mitigation action.

13. The method of claim 12, said performing an automated mitigation action comprising isolating said electronic device from communication with a remainder of said system of electronic devices.

14. The method of claim 2, wherein said scanning further comprises reversal of relocation effects on said at least one of code and data.

15. An electronic device having logic components adapted to perform the method according to claim 2.

16. A computer program comprising computer program code to, when executed upon a suitable processor, perform the method according to claim 2.

17. (canceled)

18. (canceled)

19. A scanning device having logic components adapted to receive a list of vulnerability indicators or signatures for assessing a vulnerability of an electronic device in a system of electronic devices, the scanning device comprising scanning logic to scan the system for presence of a distinguishing characteristic of at least one version of a computer program as installed in a usable format to distinguish said at least one version of the computer program in the format from at least one further version of the computer program in the format; determining logic to determine that the portion of at least one of code and data is used by the at least one version of the computer program; and responsive logic to determine that an electronic device has at least one installed instance of said at least one version of said computer program, indicator logic to indicate with at least one vulnerability indicator that the electronic device is vulnerable to said malicious activity; and output logic to output an alert to either an operator or to an automated system.

20. A machine-implemented method of generating a set of data assessing a vulnerability of an electronic device in a system of electronic devices, the method comprising scanning the system for presence of a distinguishing characteristic of at least one version of a computer program as installed in a usable format to distinguish said at least one version of the computer program in the format from at least one further version of the computer program in the format; determining that the portion of at least one of code and data is used by the at least one version of the computer program; and determining that an electronic device has at least one installed instance of said at least one version of said computer program, indicating with at least one vulnerability indicator that the electronic device is vulnerable to said malicious activity; and outputting an alert to either an operator or to an automated system.
